(19) United States
(12) Patent Application Publication
(10) Pub. No.: US 2010/0109986 A1
(43) Pub. Date: May 6, 2010

(54) DISPLAY DEVICE, DISPLAY PANEL, DISPLAY INSPECTION METHOD, AND DISPLAY PANEL MANUFACTURING METHOD

(75) Inventors: Masahiro Shiratori, Saitama (JP); Satoshi Miyaguchi, Tsurugashima-shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/593,517

(22) PCT Filed: Mar. 28, 2007
(86) PCT No.: PCT/JP2007/056645

§ 371 Date: Jan. 12, 2010

(51) Int. Cl. G09G 3/30; H01J 9/42; H01J 9/00

(52) U.S. Cl. 345/80; 445/3; 445/24

(57) ABSTRACT

An organic electroluminescent device is provided which includes a plurality of electrodes stacked on a substrate, at least one of the electrodes being transparent, an organic electroluminescent layer that is layered between the plurality of electrodes and emits light by an electric field generated between the plurality of electrodes and by applied voltage, and a light-masking sealing layer that covers the plurality of electrodes and the organic electroluminescent layer and has a transmissivity that is at least lower than that of the organic electroluminescent layer with a certain wavelength range.

### CROSS-REFERENCE TO RELATED APPLICATION

This is an application PCT/JP2007/56645, filed Mar. 28, 2007, which was not published under PCT article 21(2) in English.

### BACKGROUND OF THE INVENTION

1. Field of the Invention

The present invention relates to a display device, display panel, display panel inspection method, and display panel manufacturing method comprising an organic electroluminescent device wherein an organic electroluminescent layer emits light by an electric field generated in a plurality of electrodes.

2. Description of the Related Art

In recent years, display devices that employ a so-called organic electroluminescent device have been developed as the next generation display to replace the liquid crystal display. A display that employs such an electroluminescent device (hereinafter “organic EL display”) is capable of achieving high-brightness light emission even at a low voltage.

Such an organic EL display has attracted much attention as a self-luminous planar display device, and emits light with high light emission efficiency based on a simple device structure. Specifically, the organic electroluminescent device of the organic EL display is a device wherein holes and electrons respectively injected from a plurality of opposing electrodes are combined within a light-emitting layer that employs an organic substance, thereby generating an energy that excites a fluorescent substance within the light-emitting layer, causing the device to emit light.

In the organic electroluminescent devices of recent years, a sealing technique (generally referred to as “film sealing”) by which a sealing layer having moisture barrier and gas barrier characteristics is formed as a film on a substrate on which the aforementioned electrodes and organic electroluminescent layer are formed has been employed. The principle behind this sealing technique is to cover the EL substrate with a sealing layer having moisture barrier and gas barrier characteristics so as to achieve sealing capability, and then further increase this sealing capability by using a multi-layered structure.

At this time, however, a non-luminous region of the organic electroluminescent device referred to as a “dark spot” may increase in size, resulting in a defect. The main cause of such a dark spot is a pinhole that occurs during film formation. Moisture permeation then occurs from this point defect, enlarging the non-luminous spot of the organic electroluminescent device into a circular shape. Whether or not this circular-shaped non-luminous defect will further enlarge due to subsequent moisture permeation is determined by whether or not a defect exists in the sealing layer and the size of the defective area. In related art for reducing such dark spots and the like, methods of providing a buffer layer (planarization layer) that covers the defective area, etc., are known (refer to JP, A, 10-312883).

With such a sealing technique, it is possible to reduce the number of defects in the sealing layer of organic electroluminescent devices of prior art. Nevertheless, in a case where a point defect that cannot be completely covered by a buffer layer exists, a great amount of time is generally required to recognize the spot as a large non-luminous defect of the display device prior to product shipment. Thus, in the inspection stage performed prior to shipment, the problem arises that defective organic electroluminescent device products cannot be completely sorted out.

The above-described problem is given as one example of the problems that are to be solved by the present invention.

### SUMMARY OF THE INVENTION

To solve the foregoing problem, the invention according to claim 1 is a display device comprising: a display panel having an organic electroluminescent device; and a driving circuit, the organic electroluminescent device including: a plurality of electrodes stacked on a substrate, one of the electrodes being transparent; an organic electroluminescent layer that is stacked between the plurality of electrodes and emits light by means of an electric field generated between the plurality of electrodes by an applied voltage, and a light-masking sealing layer that covers the plurality of electrodes and the organic electroluminescent layer, and has a transmissivity that is at least lower than that of the organic electroluminescent layer within a certain wavelength range; and the driving circuit providing an applied voltage between the plurality of electrodes in accordance with inputted image data so as to drive each of the organic electroluminescent devices of the display panel.

To solve the foregoing problem, the invention according to claim 4 is a display device comprising: a display panel having an organic electroluminescent device; and a driving circuit, the organic electroluminescent device including: a plurality of electrodes stacked on a substrate, one of the electrodes being transparent, an organic electroluminescent layer that is stacked between the plurality of electrodes and emits light by means of an electric field generated between the plurality of electrodes by an applied voltage, a light-emitting covering layer that covers the plurality of electrodes and the organic electroluminescent layer, and emits light by light excitation based on irradiated excitation light, and a sealing layer that seals the light-emitting covering layer and has light-masking characteristics with respect to at least a light emitted by the light-emitting covering layer; and the driving circuit providing an applied voltage between the plurality of electrodes in accordance with inputted image data so as to drive each of the organic electroluminescent devices of the display panel.

To solve the foregoing problem, the invention according to claim 7 is a display panel comprising an organic electroluminescent device, the organic electroluminescent device including: a plurality of electrodes stacked on a substrate, one of the electrodes being transparent; an organic electroluminescent layer that is stacked between the plurality of electrodes and emits light by means of an electric field generated between the plurality of electrodes by an applied voltage; and a light-masking sealing layer that covers the plurality of electrodes and the organic electroluminescent layer, and has a transmissivity that is at least lower than that of the organic electroluminescent layer within a certain wavelength range.

To solve the foregoing problem, the invention according to claim 8 is a display panel comprising an organic electroluminescent device, the organic electroluminescent device including: a plurality of electrodes stacked on a substrate, one of the electrodes being transparent; an organic electroluminescent layer that is stacked between the plurality of electrodes and emits light by means of an electric field generated between the plurality of electrodes by an applied voltage; a light-emitting covering layer that covers the plurality of electrodes and the organic electroluminescent layer, and emits light by light excitation based on irradiated excitation light; and a sealing layer that seals the light-emitting covering layer and has light-masking characteristics with respect to at least the light emitted by the light-emitting covering layer.

To solve the foregoing problem, the invention according to claim 9 is a display panel inspection method, comprising the steps of: a light irradiation step for irradiating light on a light-masking sealing layer of each organic electroluminescent device of a display panel, the display panel including the organic electroluminescent device, the organic electroluminescent having: a plurality of electrodes, stacked on a substrate, one of the electrodes being transparent; an organic electroluminescent layer that is stacked between the plurality of electrodes and emits light by means of an electric field generated between the plurality of electrodes by an applied voltage; and the light-masking sealing layer that covers the plurality of electrodes and the organic electroluminescent layer and has a transmissivity that is at least lower than that of the organic electroluminescent layer within a certain wavelength range; and a defect inspection step for determining that a defect exists in the light-masking sealing layer when a light-transmitting spot exists in the light-masking sealing layer, and for determining that a defect does not exist in the light-masking sealing layer when a light-transmitting spot does not exist in the light-masking sealing layer.

To solve the foregoing problem, the invention according to claim 10 is a display panel inspection method, comprising the steps of: a light irradiation step for irradiating light on a sealing layer of each organic electroluminescent device of a display panel, the display panel including the organic electroluminescent device, the organic electroluminescent having: a plurality of electrodes stacked on a substrate, one of the electrodes being transparent; an organic electroluminescent layer that is stacked between the plurality of electrodes and emits light by means of an electric field generated between the plurality of electrodes by an applied voltage; a light-emitting covering layer that covers the plurality of electrodes and the organic electroluminescent layer and emits light by light excitation based on irradiated excitation light, and the sealing layer that seals the light-emitting covering layer and has light-masking characteristics with respect to at least the light emitted by the light-emitting sealing layer; and a defect inspection step for determining that a defect exists in the sealing layer when a light-emitting spot exists in the sealing layer, and for determining that a defect does not exist in the sealing layer when a light-emitting spot does not exist in the sealing layer.

To solve the foregoing problem, one embodiment of the invention is a display panel manufacturing method, comprising the steps of: a first electrode formation step for stacking a transparent first electrode on a substrate; a light-emitting layer formation step for forming on the first electrode an organic electroluminescent layer that emits light by an electric field; a second electrode formation step for forming a second electrode on the organic electroluminescent layer; a sealing layer formation step for forming a light-masking sealing layer that covers the first electrode, the organic electroluminescent layer, and the second electrode and has a transmissivity that is at least lower than that of the organic electroluminescent layer within a certain wavelength; and a light irradiation step for irradiating light on the light masking sealing layer of each organic electroluminescent device of a display panel, the organic electroluminescent device comprising the substrate, the first electrode, the organic electroluminescent layer, the second electrode, and the light-masking sealing layer.

To solve the foregoing problem, one embodiment the invention is a display panel manufacturing method, comprising the steps of: a first electrode formation step for stacking a transparent first electrode on a substrate; a light-emitting layer formation step for forming on the first electrode an organic electroluminescent layer that emits light by an electric field; a second electrode formation step for forming a second electrode on the organic electroluminescent layer; a light-emitting covering layer formation step for forming a light-emitting covering layer that covers the first electrode, the organic electroluminescent layer, and the second electrode, and emits light by light excitation based on irradiated excitation light; a sealing layer formation step for forming a sealing layer that seals the light-emitting covering layer and has light-masking characteristics with respect to at least a light emitted by the light-emitting covering layer; and a light irradiation step for irradiating light on the sealing layer of each organic electroluminescent device of a display panel, the organic electroluminescent device comprising the substrate, the first electrode, the organic electroluminescent layer, the.

### BRIEF DESCRIPTION OF THE DRAWINGS

FIG. 1 is a front view illustrating an example of the outer appearance of the display device of embodiment 1.

FIG. 2 is a cross-sectional view illustrating a configuration example of the organic electroluminescent device arranged in the display panel of embodiment 1.

FIG. 3 is a cross-sectional view illustrating an example of the mode in which the organic electroluminescent device is manufactured.

FIG. 4 is a cross-sectional view illustrating an example of the mode in which the organic electroluminescent device is manufactured.

FIG. 5 is a cross-sectional view illustrating an example of the mode in which the organic electroluminescent device is manufactured.

FIG. 6 is a cross-sectional view illustrating an example of the mode in which the organic electroluminescent device is manufactured.

FIG. 7 is a cross-sectional view illustrating an example of a mode of inspecting the organic electroluminescent device of the display panel.

FIG. 8 is a cross-sectional view illustrating a configuration example of the organic electroluminescent device arranged in the display panel of embodiment 2.

FIG. 9 is a cross-sectional view illustrating an example of the mode in which the organic electroluminescent device is manufactured.

FIG. 10 is a cross-sectional view illustrating an example of a mode of inspecting the organic electroluminescent device of the display panel.

### DETAILED DESCRIPTION OF THE PREFERRED EMBODIMENTS

The following describes an embodiment of the present invention with reference to accompanying drawings.

### Embodiment 1

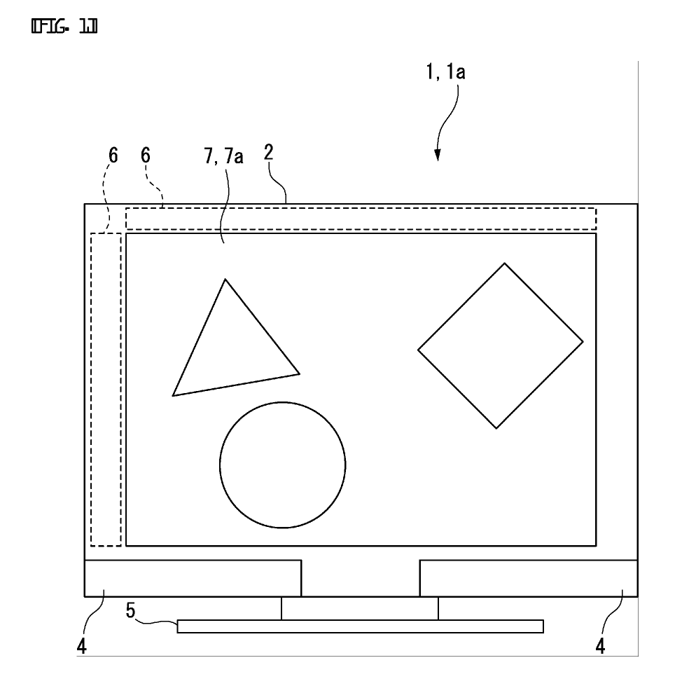

FIG. 1 is a front view illustrating an example of the outer appearance of a display device 1 comprising an organic electroluminescent device 3 of embodiment 1.

The display device 1 has a housing 2 and legs 5. The housing 2 is supported on an installation surface by the legs 5. This housing 2, based on its outer appearance, comprises a display panel 7 and two speakers 4. The display panel 7 is provided at the center of the housing 2 and, at this center of the housing 2, has a function of displaying images based on image data inputted from an external source. The speakers 4 are respectively provided on the right side and left side underneath the housing 2.

The speakers 4 have a function of outputting sound in synchronization with the image displayed on the display panel 7. The housing 2 comprises a drive circuit 6 within its interior. This drive circuit 6 performs drive control for displaying images based on the aforementioned image data on the display panel 7.

The display panel 7 is a panel that employs a so-called organic electroluminescent device (organic EL device). The display panel 7 comprises a configuration wherein a large number of organic electroluminescent devices are arranged in a matrix shape. These organic electroluminescent devices arranged in a matrix shape are driven and controlled per pixel based on the control performed by the drive circuit 6.

FIG. 2 is a cross-sectional view illustrating a configuration example of the organic electroluminescent device 3 arranged in the display panel 7 of FIG. 1.

The organic electroluminescent device 3 is a bottom-emission type organic electroluminescent device, for example, with one device formed correspondingly for each color red, green, and blue, for example. In the organic electroluminescent device 3, an anode 46 (transparent electrode), a light-emitting layer 49 (organic electroluminescent layer), and a cathode 52 (electrode) are stacked in the described order on a glass substrate 45. The organic electroluminescent device 3 is structured so that the anode 46, etc., are covered by a light-masking sealing layer 13. This light-masking sealing layer 13 employs a material having a lower transmissivity than that of the light-emitting layer 49 within a certain wavelength range.

The anode 46 and the cathode 52 (electrodes) comprise a configuration in which the two are stacked on the glass substrate 45, with one being transparent. Further, the anode 46 and the cathode 52 are respectively made of a material such as ITO (Indium Tin Oxide) and Al. Furthermore, the organic electroluminescent device 3 may employ a structure wherein an electric charge and exciter diffusion layer for capturing an electric charge and exciter within the light-emitting layer 49 is layered. The organic electroluminescent device 3 shown in the figure corresponds to one pixel section.

The glass substrate 45 is formed by a transparent material. Note that the anode 46 may be made of the material IZO rather than the above-mentioned ITO. The anode 46 comprises a transparent electrode through which a light L emitted by the light-emitting layer 49 is transmitted, as described later. The anode 46 (one of the plurality of electrodes) is formed on the glass substrate 45 at large, along the glass substrate 45. This anode 46 has a function of supplying holes to the light-emitting layer 49 described later.

The light-emitting layer 49 is a light-emitting device that employs a so-called electroluminescence (EL) phenomenon. The light-emitting layer 49 is layered between the plurality of electrodes 46 and 52, and has the function of emitting light by an electric field generated between the plurality of electrodes 46 and 52 by an applied voltage. This light-emitting layer 49 outputs its own light L by utilizing a phenomenon in which light is emitted based on energy received from an external force using an electric field.

In a case where the organic electroluminescent device 3 is a bottom-emission type, as in the present embodiment, for example, the light-emitting layer 49 largely emits the light L (external light) downward. The light L thus emitted by the light-emitting layer 49 is not only removed to an external source of the organic electroluminescent device 3 as external light, but is also sometimes lost within the organic electroluminescent device 3.

The light-masking sealing layer 13 covers the plurality of electrodes (the anode 46 and the cathode 52) and the light-emitting layer 49. This light-masking sealing layer 13 has a function of not permitting light transmission during light irradiation in the inspection method (inspection process) described later. The light-masking sealing layer 13 also has the function of masking light so that the light emitted by the light-emitting layer 49 is not leaked to the outside. The light-masking sealing layer 13 has gas barrier characteristics. The material employed in the light-masking sealing layer 13 may be either a metal material, such as Al, Cu, or Cr, a metal oxide or metal nitride having low transmissivity, such as CrN. The thickness of the light-masking sealing layer 13 is at least, for example, greater than or equal to 10 nm and less than or equal to 100 μm, preferably greater than or equal to 100 nm and less than or equal to 10 μm, for example.

### Operation Example of the Organic Electroluminescent Device 3

The organic electroluminescent device 3 and the display device 1 into which the organic electroluminescent device 3 is built thus comprise the above-described configuration, and an example of the operation of the organic electroluminescent device 3 and the display device 1 into which the organic electroluminescent device 3 is built will now be described.

In the display device 1 illustrated in FIG. 1, a large number of organic electroluminescent devices 3 are arranged in a matrix shape in the display panel 7 thereof, and the large number of organic electroluminescent devices 3 operate as described below based on the control performed by the drive circuit 6.

First, the drive circuit 6 drives each of the organic electroluminescent devices 3 based on inputted imaged data so as to display an image based on the image data on the display panel 7. Then, in each of the organic electroluminescent devices 3, this drive circuit 6 applies DC voltage from a predetermined power supply (not shown) between the anode 46 and the cathode 52 illustrated in FIG. 2.

When DC voltage is thus applied to the anode 46 and the cathode 52, the anode 46 discharges holes. The holes discharged from the anode 46 arrive at the light-emitting layer 49. In this manner, the light-emitting layer 49 is capable of receiving holes from the anode 46. On the other hand, the cathode 52 injects electrons into the light-emitting layer 49. In this manner, the light-emitting layer 49 is capable of receiving electrons discharged from the cathode 52.

The light-emitting layer 49 operates as described below based on the holes and electrons thus injected. The injected holes and electrons are recombined inside the light-emitting layer 49, and there are in an excited state, which is in an unstable, high-energy state. The light-emitting layer 49 then promptly returns to its original ground state, which is a stable, low-energy state. At this time, the light-emitting layer 49 emits the light L based on the difference in energy between the excited state and the ground state.

With this arrangement, the display device 1 illustrated in FIG. 1 emits the light L from the pixels corresponding to each of the organic electroluminescent devices 3 based on the control performed by the drive circuit 6, making it possible to display a predetermined image on the display panel 7. At this time, the display device 1 is capable of outputting sound from the speakers 4 in synchronization with the display of this image.

### Display Panel Manufacturing Method 1 of Embodiment 1

With the operation example of the organic electroluminescent device 3 and the display device 1 as described above, an example of the manufacturing method of the organic electroluminescent device 3 arranged in the display panel 7 will now be described with reference to FIG. 1 and FIG. 2. Note that the manufacturing method of the display panel 7 includes the inspection method of the organic electroluminescent device 3.

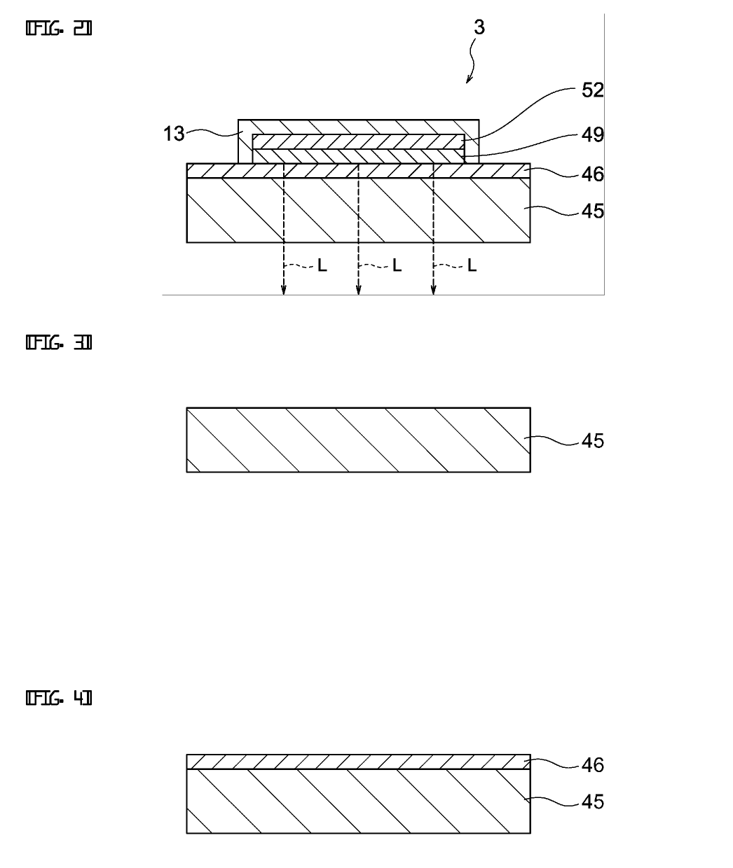

FIG. 3 to FIG. 7 are each cross-sectional views illustrating an example in which the organic electroluminescent device 3 of the display panel 7 is manufactured according to the manufacturing method of the display panel 7 of embodiment 1.

First, the glass substrate 45 is prepared as illustrated in the figures, and the transparent anode 46 is formed as a film on top of this glass substrate 45 as illustrated (first electrode formation step). The light-emitting layer 49 is then formed on top of the anode 46 thus formed, at a position where the organic electroluminescent device 3 is to be formed, as illustrated in the figures (light-emitting layer formation step).

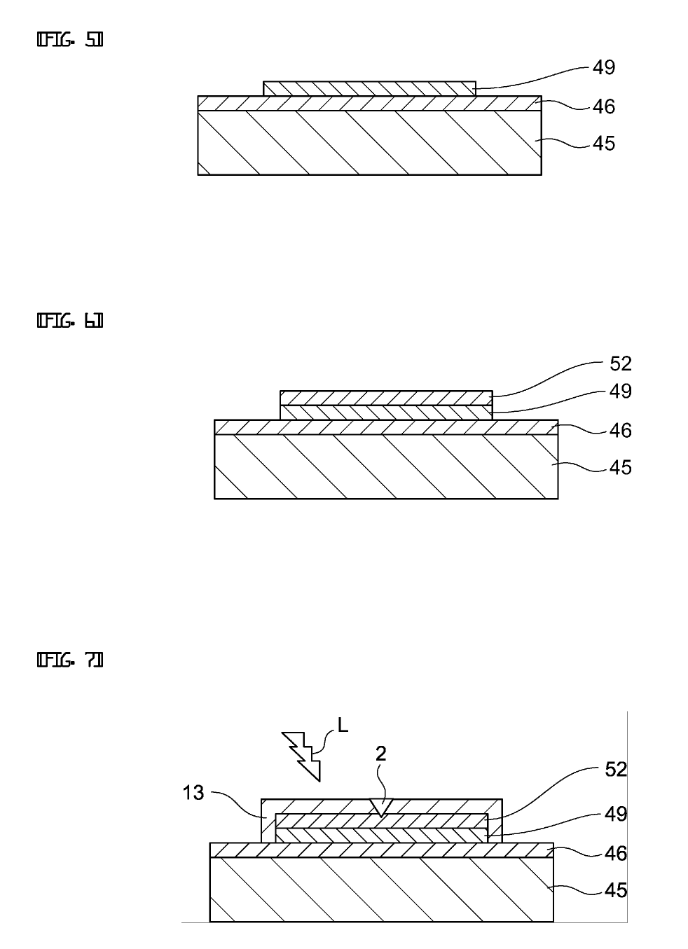

Furthermore, as illustrated in FIG. 6, the cathode 52 is formed as a film on top of this light-emitting layer 49 (second electrode formation step). The light-masking sealing layer 13 is then formed on top of the cathode 52 so as to cover not only the cathode 52 but the light-emitting layer 49 as well as the cathode 52 as illustrated in FIG. 2 (part of the light-masking sealing layer formation step). This light-masking sealing layer 13 employs a sealing base material having a transmissivity that is at least lower than that of the light-emitting layer 49 within a certain wavelength range, as described above. This sealing base material may be formed by a vapor deposition method based on CVD (Chemical Vapor Deposition) or sputtering, for example, or may be formed using an evaporation method using vacuum evaporation, for example. In such a case, the sealing base material forms a 300 nm CrN layer from reactive sputtering using Cr as the sputtering target and N₂ as the reactive gas.

While the light-masking sealing layer 13 is thus formed, the defect 2 such as illustrated in the FIG. 7 sometimes occurs in the light-masking sealing layer 13 when the device is thus sealed by the light-masking sealing layer 13. This defect 2 is very small, for example, and difficult to visually recognize as is. In this embodiment, the sealed stated achieved by the light-masking sealing layer 13 is then further inspected as described below.

### Display Panel Inspection Process of Embodiment 1

First, light is irradiated from the glass substrate side on the organic electroluminescent device 3 as illustrated in the figure. Then, since the CrN, for example, forms an even film serving as the light-masking sealing layer 13 on the organic electroluminescent device 3, the transmitted light is not detected if the defect 2 does not exist in the light-masking sealing layer 13. Nevertheless, in a particular organic electroluminescent device 3, it is possible to confirm a light-transmitting spot 2 of a diameter of about 2 μm, for example, in the light-masking sealing layer 13. That is, this light-transmitting spot is the area of the defect 2 in the light-masking sealing layer 12 (CrN layer) responsible for gas barrier characteristics.

Thus, since such the defect 2 is visually recognizable as a light-transmitting spot, according to this inspection method, it is possible to quickly and easily recognize the presence of a (expanding) spot-shaped defect 2 that enlarges with the passage of time at ambient temperature, prior to shipment of the organic electroluminescent device 3, for example. This makes it possible to prevent outflow to the market of the defective display device 1 that employs the display panel 7 comprising a built-in organic electroluminescent device 3 having the defect 2, for example.

In this embodiment, since the light-masking sealing layer 13 is employed as the sealing member as described above, the defect 2 is detectable as a light-transmitting spot or abnormal light-transmitting spot from the irradiation of white light, etc., in the inspection process.

The display device 1 of the above embodiment comprises the display panel 7 having the organic electroluminescent device 3; and the driving circuit, the organic electroluminescent device 3 comprising the plurality of electrodes 46 and 52 (anode and cathode) stacked on the substrate 45, one of the electrodes 46, 52 being transparent, the organic electroluminescent layer 49 (light-emitting layer) that is layered between the plurality of electrodes 46 and 52 and emits light by means of an electric field generated between the plurality of electrodes 46 and 52 by an applied voltage, and the light-masking sealing layer that covers the plurality of electrodes 46 and 52 and the organic electroluminescent layer 49 and has a transmissivity that is at least lower than the organic electroluminescent layer 49 (light-emitting layer) within a certain wavelength range; and the drive circuit providing an applied voltage between the plurality of electrodes 46 and 52 in accordance with inputted image data so as to drive each of the organic electroluminescent devices 3 of the display panel 7.

In the display panel 7 of the above embodiment is arranged the organic electroluminescent device 3 comprising the plurality of electrodes 46 and 52 stacked on the substrate, one of the electrodes being transparent; the organic electroluminescent layer 49 that is layered between the plurality of electrodes 46 and 52 and emits light by means of an electric field generated between the plurality of electrodes 46 and 52 by an applied voltage, and the light-masking sealing layer 13 that covers the plurality of electrodes 46 and 52 and the organic electroluminescent layer 49, and has a transmissivity that is at least lower than that of the organic electroluminescent layer 49 within a certain wavelength range.

With such a configuration, when the light of the above-described certain wavelength range is irradiated from the outside toward the substrate 45, the light passes through the organic electroluminescent layer 49 (light-emitting layer) and reaches the light-masking sealing layer 13. At this time, when the defect 2 has occurred in the light-masking sealing layer 13, light leaks out from the area of the defect 2 only, even though all light should be masked by the light-masking sealing layer 13. This makes it possible to easily visually recognize only the area of the defect 2 as a light-emitting spot. With this arrangement, it is possible to easily visually detect whether or not the defect 2 is present in the light-masking sealing layer 13 using the simple method of irradiating light from the outside, through the substrate 45, and toward the light-masking sealing layer 13.

To identify prior to shipment whether the defect 2 (dark spot) is a point defect having expandability, any known general analytical method may be used, such as surface shape analysis by a white light interference microscope or AFM. While these methods make it possible to measure the convexoconcave shape of the light-masking sealing layer 13 and detect the size of the defect 2 on the overall surface of the display panel 7, difficulties arise when an attempt is made to detect the defect 2 having an extremely small size on the overall surface of the display panel 7. The information thus measured is referred to as height information. Nevertheless, according to this embodiment, it is possible to easily detect the defect 2, even if the defect 2 is of an extremely small size. Further, when the display panel 7 (organic EL panel) has a large surface area and three-dimensional analysis is employed, surface shape analysis related to the presence of such the defect 2 requires much time, and any attempt to ascertain the presence of the defect 2 in the light-masking sealing layer 13 by height information only is confronted with difficulties. On the other hand, the defect 2 is readily detectable within a short period of time according to this embodiment, making it possible to identify whether or not the defect 2 exists in the light-masking sealing layer 13.

The display device 1 and the display panel 7 of this embodiment each further comprise the light-masking sealing layer 13 formed by a vapor deposition method in addition to the above configuration. With this arrangement, the light-masking sealing layer 13 can be simply formed using a general film formation method.

The display device 1 and the display panel 7 of this embodiment each further comprise the light-masking sealing layer 13 formed by an evaporation method in addition to the above configuration. With this arrangement, the light-masking sealing layer 13 can be simply formed using a general film formation method.

The inspection method of the display panel 7 of the above embodiment comprises the step of: a light irradiating step for irradiating light on the light-masking sealing layer 13 of each of the organic electroluminescent devices 3 of the display panel 7, the display panel 7 including the organic electroluminescent devices 3, the organic electroluminescent devices 3 having: the plurality of electrodes 46 and 52 stacked on the substrate 45, one of the electrodes 46, 52 being transparent; the organic electroluminescent layer 49 that is layered between the plurality of electrodes 46 and 52 and emits light by means of an electric field generated between the plurality of electrodes 46 and 52 by an applied voltage; and the light-masking sealing layer 13 that covers the plurality of electrodes 46 and 52 and the organic electroluminescent layer 49 and has a transmissivity that is at least lower than that of the organic electroluminescent layer 49 within a certain wavelength range; and a defect inspection step for determining that a defect exists in the light-masking sealing layer 13 in a case where a light-transmitting spot exists in the light-masking sealing layer 13 and for determining that a defect does not exist in the light-masking sealing layer 13 in a case where a light-transmitting spot does not exist in the light-masking sealing layer 13.

With a display panel 7a manufactured using such a manufacturing method, when light of the above-described certain wavelength range is irradiated from the outside toward the substrate 45, the light passes through the organic electroluminescent layer 49 (light-emitting layer) and reaches the light-masking sealing layer 13. At this time, when the defect 2 has occurred in the light-masking sealing layer 13, light leaks out from the area of the defect 2 only, even though all light should be masked by the light-masking sealing layer 13. This makes it possible to easily visually recognize only the area of the defect 2 as a light-emitting spot. With this arrangement, it is possible to easily visually detect whether or not the defect 2 is present in the light-masking sealing layer 13 using the simple method of irradiating light from the outside, through the substrate 45, and toward the light-masking sealing layer 13.

While the above-described surface shape analysis method makes it possible to measure the convexoconcave shape of the light-masking sealing layer 13 and detect the size of the defect 2 on the overall surface of the display panel 7, difficulties arise when an attempt is made to detect the defect 2 having an extremely small size on the overall surface of the display panel 7. Nevertheless, according to this embodiment, it is possible to easily detect the defect 2, even if the defect 2 is of an extremely small size. Further, when the display panel 7 (organic EL panel) has a large surface area and three-dimensional analysis is employed, surface shape analysis related to the presence of such the defect 2 requires much time, and any attempt to ascertain the presence of the defect 2 in the light-masking sealing layer 13 by height information only is confronted with difficulties. On the other hand, the defect 2 is readily detectable within a short period of time according to this embodiment, making it possible to identify whether or not the defect 2 exists in the light-masking sealing layer 13.

### Embodiment 2

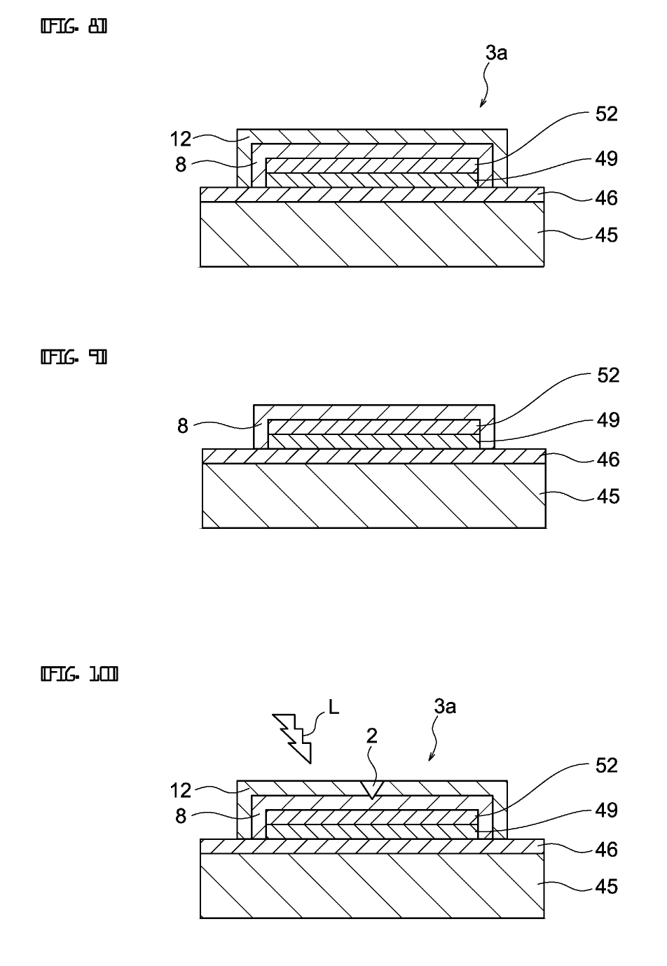

FIG. 8 is a cross-sectional view illustrating a configuration example of an organic electroluminescent device 3a arranged in the display panel 7a of a display device 1a of embodiment 2.

The organic electroluminescent device 3a of embodiment 2 has substantially the same configuration and operates substantially in the same manner as the organic electroluminescent device 3 of embodiment 1. The same reference numerals as those employed in FIG. 1 to FIG. 7 of embodiment 1 will therefore be used for the same components and operation, and descriptions thereof will be omitted. The following will describe the organic electroluminescent device 3a while focusing on unique points.

The organic electroluminescent device 3a of embodiment 2 differs from the organic electroluminescent device 3 of embodiment 1 in that a light-emitting covering layer 8 and a sealing layer 12 are formed in place of the light-masking sealing layer 13. Specifically, the organic electroluminescent device 3a comprises the following configuration.

First, the organic electroluminescent device 3a is a bottom-emission type organic electroluminescent device, for example, with one device formed correspondingly for each color red, green, and blue, for example. This organic electroluminescent device 3a comprises a structure wherein the anode 46 (transparent electrode), the light-emitting layer 49 (organic electroluminescent layer), and the cathode 52 (electrode) are stacked in the described order on the glass substrate 45 and then covered by the light-emitting covering layer 8. Further, on this light-emitting covering layer 8 is formed the sealing layer 12 which seals the light-emitting covering layer 8 and has light-masking characteristics with respect to the light emitted by the light-emitting covering layer 8. That is, the sealing layer 12 transmits excitation light (ultraviolet light from an Hg lamp, for example) to generate light excitation on the light-emitting covering layer 8, and has the function of masking the light (orange light of an approximate 580 nm wavelength, for example) emitted by light excitation by the light-emitting covering layer 8.

The anode 46 and the cathode 52 (electrodes) comprise a configuration in which the two are stacked on the glass substrate 45, with one being transparent. Further, the anode 46 and the cathode 52 are respectively made of a material such as ITO (Indium Tin Oxide) and Al. Furthermore, the organic electroluminescent device 3a may employ a structure wherein an electric charge and exciter diffusion layer for capturing an electric charge and exciter within the light-emitting layer 49 is layered. The organic electroluminescent device 3a shown in the figure corresponds to one pixel section.

The glass substrate 45 is formed by a transparent material. Note that the anode 46 may be made of the material IZO rather than the above-mentioned ITO. The anode 46 comprises a transparent electrode through which a light L emitted by the light-emitting layer 49 is transmitted, as described later. The anode 46 (one of the plurality of electrodes) is formed on the glass substrate 45 at large, along the glass substrate 45. This anode 46 has a function of supplying holes to the light-emitting layer 49 described later.

The light-emitting layer 49 is a light-emitting device that employs a so-called electroluminescence (EL) phenomenon. The light-emitting layer 49 is layered between the plurality of electrodes 46 and 52, and has the function of emitting light by an electric field generated between the plurality of electrodes 46 and 52 by an applied voltage. This light-emitting layer 49 outputs its own light L by utilizing a phenomenon in which light is emitted based on energy received from an external source using an electric field.

In a case where the organic electroluminescent device 3 is a bottom-emission type, as in the present embodiment, for example, the light-emitting layer 49 largely emits the light L (external light) downward. The light L thus emitted by the light-emitting layer 49 is not only removed to an external source of the organic electroluminescent device 3a as external light, but is also sometimes lost within the organic electroluminescent device 3a.

The sealing layer 12 also has the function of masking light so that the light emitted by the light-emitting covering layer 8, which absorbed light, is not leaked to the outside. The material employed in the sealing layer 12 has gas barrier characteristics, and may be either a metal material, such as Al, Cu, or Cr, or a metal oxide or metal nitride having low transmissivity, such as CrN. The thickness of the sealing layer 12 is at least, for example, greater than or equal to 10 nm and less than or equal to 100 μm, preferably greater than or equal to 100 nm and less than or equal to 10 μm, for example.

The light-emitting covering layer 8 may be an inorganic or organic material, and does not necessarily have to have gas barrier characteristics. The inorganic material employed may be a direct transition-type semiconductor material, such as GaN, and the emission center material employed may be SiOx, SiNx, AlOx, AlNx, or the like topped with a rare earth element such as Tb (green emission), a transition metal element such as Mn (orange emission), or the like. The organic material employed may be a light-emitting low molecular organic material such as α-NPD, or a high-molecular organic material. Similarly, the thickness of the light-emitting covering layer 8 is at least greater than or equal to 10 nm and less than or equal to 100 μm, preferably greater than or equal to 100 nm and less than or equal to 10 μm.

### Display Panel Manufacturing Method of Embodiment 2

With the operation example of the organic electroluminescent device 3a and the display device 1a as described above, an example of the manufacturing method of the organic electroluminescent device 3a arranged in the display panel 7a will now be described with reference to FIG. 1 and FIG. 8. Note that the manufacturing method of the display panel 7a includes the inspection method of the organic electroluminescent device 3a.

FIG. 3 to FIG. 6 and FIG. 9 to FIG. 10 are each cross-sectional views illustrating an example of the mode in which the organic electroluminescent device 3 of the display panel 7a is manufactured according to the manufacturing method of the display panel 7a of embodiment 2.

First, the glass substrate 45 is prepared as illustrated in FIG. 3, and the transparent anode 46 is formed as a film on top of this glass substrate 45 as illustrated in FIG. 4 (first electrode formation step). The light-emitting layer 49 is then formed on top of the anode 46 thus formed, at a position where the organic electroluminescent device 3 is to be formed, as illustrated in FIG. 5 (light-emitting layer formation step).

Furthermore, as illustrated in FIG. 6, the cathode 52 is formed as a film on top of this light-emitting layer 49 (second electrode formation step). A covering base material is then further formed on top of the cathode 52 so as to cover not only the cathode 52 but the light-emitting layer 49 as well as the cathode 52 (part of the light-emitting covering layer formation step). This covering base material may be formed by a vapor deposition method based on CVD (Chemical Vapor Deposition) or sputtering, for example, or may be formed using an evaporation method based on vacuum evaporation, for example. In this case, the covering base material is formed with α-NPD by vacuum evaporation, for example, in an amount of approximately 300 nm. In this manner, the organic electroluminescent device 3a is thus manufactured.

On the organic electroluminescent device 3a thus configured is formed the light-emitting covering layer 8 as illustrated in FIG. 8 (part of the light-emitting covering layer formation step). Further, on this light-emitting covering layer 8 is formed the sealing layer 12 by sputtering, for example (sealing layer formation step). A 300 nm CrN layer is formed from reactive sputtering using, for example, Cr as the sputtering film formation target and N₂ as the reactive gas.

While the light-emitting covering layer 8 is thus formed, the defect 2 such as illustrated in the figure sometimes occurs in the light-emitting covering layer 8 when the device is thus sealed by the light-emitting covering layer 8. This defect 2 is very small, for example, and difficult to visually recognize as is. In this embodiment, the sealed stated achieved by the light-emitting covering layer 8 is then inspected as described below.

### Display Panel Inspection Process of Embodiment 2

First, the organic electroluminescent device 3a irradiates excitation light from the side closer to the sealing layer 12 as illustrated in FIG. 10. The light-emitting covering layer 8 is excited by the excitation light (ultraviolet light L from an Hg lamp, for example) thus irradiated, causing excitation of only the part of the light-emitting covering layer 8 under the defect 2, and light emits therefrom. Then, light emission is not detected from any area of the light-emitting covering layer 8 other than the area of the defect 2 since an even layer of CrN, for example, is formed thereon. Nevertheless, in a certain organic electroluminescent device 3a, it is possible to confirm the emission of blue light from the light-emitting covering layer 8 which comprises the material α-NPD, for example, as a light-emitting spot having an approximate 2 μm diameter. That is, this light-emitting spot is from the area of the defect 2 in the sealing layer 12 (CrN layer, for example) responsible for gas barrier characteristics.

Thus, since such the defect 2 is visually recognizable as a light-emitting spot according to this inspection method, it is possible to quickly and easily recognize the presence of an (expanding) spot-shaped defect 2 that enlarges with the passage of time at ambient temperature, prior to shipment of the organic electroluminescent device 3a, for example. This makes it possible to prevent outflow to the market of the defective display device 1a, for example, that employs the display panel 7a comprising a built-in organic electroluminescent device 3a having the defect 2.

In this embodiment, the light-emitting covering layer 8 that contains a material that emits light by light excitation is thus employed as the sealing member, enabling detection of the defect 2 as a light-emitting spot by irradiation of excitation light such as ultraviolet light or the like from the light-emitting covering layer 8.

The display device 1 of the above embodiment comprises the display panel 7 having the organic electroluminescent device 3; and the driving circuit 6, the organic electroluminescent device 3 including the plurality of electrodes 46 and 52 stacked on the substrate 45 (glass substrate), one of the electrodes 46, 52 being transparent, the organic electroluminescent layer 49 (light-emitting layer) that is layered between the plurality of electrodes 46 and 52 and emits light by means of an electric field generated between the plurality of electrodes 46 and 52 by an applied voltage, the light-emitting covering layer 8 that covers the plurality of electrodes 46 and 52 and the organic electroluminescent layer 49 and emits light by light excitation based on irradiated excitation light, and the sealing layer 12 that seals the light-emitting covering layer 8 and has light-masking characteristics with respect to at least the light emitted by the light-emitting covering layer 8; and the drive circuit 6 providing an applied voltage between the plurality of electrodes 46 and 52 in accordance with inputted image data so as to drive each of the organic electroluminescent devices 3 of the display panel 7.

In the display panel 7 of the embodiment is arranged the organic electroluminescent device 3 comprising the plurality of electrodes 46 and 52 stacked on the substrate 45 (glass substrate), one of the electrodes being transparent; the organic electroluminescent layer 49 (light-emitting layer) that is layered between the plurality of electrodes 46 and 52 and emits light by means of an electric field generated between the plurality of electrodes 46 and 52 by an applied voltage; the light-emitting covering layer 8 that covers the plurality of electrodes 46 and 52 and the organic electroluminescent layer 49, and emits light by light excitation based on irradiated excitation light; and the sealing layer 12 that seals the light-emitting covering layer 8 and has light-masking characteristics with respect to at least the light emitted by the light-emitting covering layer 8.

With such a configuration, when the excitation light is irradiated on the sealing layer 12 from the outside, the light arrives at the light-emitting covering layer 8 via the defect 2 of the sealing layer 12. The light-emitting covering layer 8 then emits light by light excitation based on the absorbed excitation light. At this time, when the defect 2 has occurred in the sealing layer 12, light is leaked from the dark section masked by the sealing layer 12 only in the area of the defect 2. This makes it possible to easily visually recognize only the area of the defect 2 as a light-emitting spot. With this arrangement, the sealing layer 12 can be easily visually inspected for the defect 2 using the simple method of irradiating excitation light on the sealing layer 12.

While the above-described surface shape analysis method makes it possible to measure the convexoconcave shape of the sealing layer 12 and detect the size of the defect 2 on the overall surface of the display panel 7a as described above, difficulties arise when an attempt is made to detect the defect 2 having an extremely small size on the overall surface of the display panel 7a. Nevertheless, according to this embodiment, it is possible to easily detect the defect 2, even if the defect 2 is of an extremely small size. Further, when the display panel 7a (organic EL panel) has a large surface area and three-dimensional analysis is employed, surface shape analysis related to the presence of such the defect 2 requires much time, and any attempt to ascertain the presence of the defect 2 in the sealing layer 12 by the aforementioned height information only is confronted with difficulties. On the other hand, the defect 2 is readily detectable within a short period of time according to this embodiment, making it possible to identify whether or not the defect 2 exists in the sealing layer 12.

The display device 1a and the display panel 7a are each provided with the sealing layer 12 formed by a vapor deposition method. With this arrangement, the sealing layer 12 can be simply formed using a general film formation method.

The display device 1a and the display panel 7a are each provided with the sealing layer 12 formed by an evaporation method. With this arrangement, the sealing layer 12 can be simply formed using a general film formation method.

The inspection method of the display panel 7 of the above embodiment comprises the steps of: a light irradiating step for irradiating light on the sealing layer 12 of each of the organic electroluminescent devices 3 of the display panel 7, the display panel 7 including the organic electroluminescent device 3, the organic electroluminescent device 3 having; the plurality of electrodes 46 and 52 stacked on the substrate 45, one of the electrodes 46, 52 being transparent; the organic electroluminescent layer 49 that is layered between the plurality of electrodes 46 and 52 and emits light by means of an electric field generated between the plurality of electrodes 46 and 52 by an applied voltage; the light-emitting covering layer 8 that covers the plurality of electrodes 46 and 52 and the organic electroluminescent layer 49 and emits light by light excitation based on irradiated excitation light, and the sealing layer 12 that seals the light-emitting covering layer 8 and has light-masking characteristics with respect to at least the light emitted by the light-emitting covering layer 8; and a defect inspection step for determining that the defect 2 exists in the sealing layer 12 in a case where a light-emitting spot exists in the sealing layer 12, and for determining that a defect does not exist in the sealing layer 12 in a case where a light-emitting spot does not exist in the sealing layer 12.

With such a configuration, when excitation light is irradiated on the sealing layer 12 from the outside, the light arrives at the light-emitting covering layer 8 via the defect 2 of the sealing layer 12. The light-emitting covering layer 8 then emits light by light excitation based on the absorbed excitation light. At this time, when the defect 2 has occurred in the sealing layer 12, light is leaked from the dark section masked by the sealing layer 12 only in the area of the defect 2. This makes it possible to easily visually recognize only the area of the defect 2 as a light-emitting spot. With this arrangement, the sealing layer 12 can be easily visually inspected for the defect 2 using the simple method of irradiating excitation light on the sealing layer 12.

According to this embodiment, compared to a case where surface shape analysis by a white light interference microscope or AFM such as described above is employed, it is possible to easily detect the defect 2 having an extremely small size as described above. Further, surface shape analysis related to the presence of such the defect 2 is confronted with difficulties when an attempt is made to ascertain the presence of the defect 2 in the sealing layer 12 based on height information only. However, the defect 2 is readily detectable within a short period of time according to this embodiment, making it possible to identify whether or not the defect 2 exists in the sealing layer 12.

The manufacturing method of the display panel 7 of the above embodiment comprises a first electrode formation step for stacking a transparent first electrode 46 on the substrate 45 (glass substrate); a light-emitting layer formation step for forming on the first electrode 46 the organic electroluminescent layer 49 (light-emitting layer) that emits light by an electric field, a second electrode formation step for forming the second electrode 52 on the organic electroluminescent layer 49, a light-emitting covering layer formation step for forming the light-emitting covering layer 8 that covers the first electrode 46, the organic electroluminescent layer 49, and the second electrode 52, and emits light by light excitation based on irradiated excitation light; a sealing layer formation step for forming the sealing layer 12 that seals the light-emitting covering layer 8 and has light-masking characteristics with respect to the light emitted by the light-emitting covering layer 8; and the light irradiation step for irradiating light on the sealing layer 12 of each of the organic electroluminescent devices 3 of the display panel 7, the organic electroluminescent device 3 comprising the substrate 45, the first electrode 46, the organic electroluminescent layer 49, the second electrode 52, the light-emitting covering layer 8, and the sealing layer 12.

When excitation light is irradiated on the sealing layer 12 from outside the display panel 7 manufactured by such a manufacturing method, the excitation light transmitted through the sealing layer 12 arrives at the light-emitting covering layer 8 or at the light-emitting covering layer 8 via the defect 2 of the sealing layer 12. The light-emitting covering layer 8 then emits light by light excitation based on the absorbed excitation light. At this time, when the defect 2 has occurred in the sealing layer 12, light is leaked from the dark section masked by the sealing layer 12 only in the area of the defect 2. This makes it possible to easily visually recognize only the area of the defect 2 as a light-emitting spot. With this arrangement, the sealing layer 12 can be easily visually inspected for the defect 2 using the simple method of irradiating excitation light on the sealing layer 12.

According to this embodiment, compared to a case where surface shape analysis by a white light interference microscope or AFM such as described above is employed, it is possible to easily detect the defect 2 having an extremely small size as described above. Further, surface shape analysis related to the presence of such the defect 2 is confronted with difficulties when an attempt is made to ascertain the presence of the defect 2 in the sealing layer 12 based on height information only. Nevertheless, the defect 2 is readily detectable within a short period of time according to this embodiment, making it possible to identify whether or not the defect 2 exists in the sealing layer 12.

Note that this embodiment is not limited to the above, and various modifications are possible. In the following, details of such modifications will be described one by one.

While the above embodiments have described illustrative scenarios in which the organic electroluminescent devices 3 and 3a each comprise the light-emitting layer 49 between the anode 46 and the cathode 52, the present invention is not limited thereto, allowing the following as well.

That is, in the organic electroluminescent devices 3 and 3a, a mode where a hole injection layer 47 and a hole transport layer 48 are each provided between the anode 46 and the light-emitting layer 49, as well as a mode where an electron transport layer 50 and an electron injection layer 51 are provided between the light-emitting layer 49 and the cathode 52 are allowed. The material used for the hole injection layer 47, the hole transport layer 48, the electron transport layer 50, and the electron injection layer 51 may be CuPc, NPB, Alg₃, and LiF, respectively.

The hole injection layer 47 is stacked so that the holes are readily removable from the anode 46. The hole transport layer 48 has a function of transporting the holes removed from the anode 46 by the hole injection layer 47 to the light-emitting layer 49. The hole injection layer 47 is mainly stacked on the anode 46. The hole transport layer 48 is stacked on the hole injection layer 47.

The electron transport layer is stacked on the light-emitting layer 49. Furthermore, the electron injection layer 51 is stacked on the electron transport layer 50. The cathode 52 is formed on the electron injection layer 51. Of these, the electron injection layer 51 has the function of readily removing the electrons from the cathode 52. Additionally, the electron transport layer 50 has the function of efficiently transporting the electrons removed from the cathode 52 by the electron injection layer 51 to the light-emitting layer 49.

The sealing technique applied in the above embodiments may be an organic memory, sensor, or solar cell sealing technique for both the organic electroluminescent devices 3 and 3a. Further, in the above embodiments, various modes may be used for the configuration of sections other than the sections touched upon in the descriptions above. While the above embodiments have described illustrative scenarios in which the glass substrate 45 is used as the substrate, the present invention is not limited thereto, allowing use of a variety of materials. Further, in the above embodiments, the driving method of the display device 1 is not particularly limited.

Further, in the inspection process of the above embodiment 1, the wavelength of the light used in the inspection is not limited as long as it is not harmful to the organic electroluminescent device, and may be general white light, for example. Additionally, the excitation light irradiated to detect the defect 2 in the inspection process of the above embodiment 2 is not limited to ultraviolet light, allowing use of various wavelengths. Specifically, as the excitation light in the above embodiment 2, an excitation wavelength having the highest light emission efficiency is preferred. Furthermore, as the excitation light in the above embodiment 2, use of an excitation light having a long wavelength that minimizes damage to the organic electroluminescent device 3, etc., is preferred.

1-11. (canceled)

12. A display device comprising:
a display panel having an organic electroluminescent device; and
a driving circuit,
said organic electroluminescent device including:
a plurality of electrodes stacked on a substrate, one of said electrodes being transparent;
an organic electroluminescent layer that is stacked between said plurality of electrodes and emits light by means of an electric field generated between said plurality of electrodes by an applied voltage, and a light-masking sealing layer that covers said plurality of electrodes and said organic electroluminescent layer, and has a transmissivity that is at least lower than that of said organic electroluminescent layer within a certain wavelength range; and said driving circuit providing an applied voltage between said plurality of electrodes in accordance with inputted image data so as to drive each of said organic electroluminescent devices of said display panel.

13. The display device according to claim 12, wherein:
said light-masking sealing layer is formed by a vapor deposition method.

14. The display device according to claim 12, wherein:
said light-masking sealing layer is formed by an evaporation method.

15. A display device comprising:
a display panel having an organic electroluminescent device; and
a driving circuit, said organic electroluminescent device including:
a plurality of electrodes stacked on a substrate, one of said electrodes being transparent, an organic electroluminescent layer that is stacked between said plurality of electrodes and emits light by means of an electric field generated between said plurality of electrodes by an applied voltage, a light-emitting covering layer that covers said plurality of electrodes and said organic electroluminescent layer, and emits light by light excitation based on irradiated excitation light, and a sealing layer that seals said light-emitting covering layer and has light-masking characteristics with respect to at least a light emitted by said light-emitting covering layer; and said driving circuit providing an applied voltage between said plurality of electrodes in accordance with inputted image data so as to drive each of said organic electroluminescent devices of said display panel.

16. The display device according to claim 15, wherein:
said sealing layer is formed by a vapor deposition method.

17. The display device according to claim 15, wherein;
said sealing layer is formed by an evaporation method.

18. A display panel comprising an organic electroluminescent device,
said organic electroluminescent device including:
a plurality of electrodes stacked on a substrate, one of said electrodes being transparent;
an organic electroluminescent layer that is stacked between said plurality of electrodes and emits light by means of an electric field generated between said plurality of electrodes by an applied voltage; and a light-masking sealing layer that covers said plurality of electrodes and said organic electroluminescent layer, and has a transmissivity that is at least lower than that of said organic electroluminescent layer within a certain wavelength range.

19. A display panel comprising an organic electroluminescent device,
said organic electroluminescent device including:
a plurality of electrodes stacked on a substrate, one of said electrodes being transparent;
an organic electroluminescent layer that is stacked between said plurality of electrodes and emits light by means of an electric field generated between said plurality of electrodes by an applied voltage;
a light-emitting covering layer that covers said plurality of electrodes and said organic electroluminescent layer, and emits light by light excitation based on irradiated excitation light; and a sealing layer that seals said light-emitting covering layer and has light-masking characteristics with respect to at least the light emitted by said light-emitting covering layer.

20. A display panel inspection method, comprising the steps of:
a light irradiation step for irradiating light on a light-masking sealing layer of each organic electroluminescent device of a display panel, said display panel including said organic electroluminescent device, said organic electroluminescent having: a plurality of electrodes stacked on a substrate, one of said electrodes being transparent; an organic electroluminescent layer that is stacked between said plurality of electrodes and emits light by means of an electric field generated between said plurality of electrodes by an applied voltage; and said light-masking sealing layer that covers said plurality of electrodes and said organic electroluminescent layer and has a transmissivity that is at least lower than that of said organic electroluminescent layer within a certain wavelength range; and a defect inspection step for determining that a defect exists in said light-masking sealing layer when a light-transmitting spot exists in said light-masking sealing layer, and for determining that a defect does not exist in said light-masking sealing layer when a light-transmitting spot does not exist in said light-masking sealing layer.

21. A display panel inspection method, comprising the steps of:
a light irradiation step for irradiating light on a sealing layer of each organic electroluminescent device of a display panel, said display panel including said organic electroluminescent device, said organic electroluminescent having: a plurality of electrodes stacked on a substrate, one of said electrodes being transparent; an organic electroluminescent layer that is stacked between said plurality of electrodes and emits light by means of an electric field generated between said plurality of electrodes by an applied voltage; a light-emitting covering layer that covers said plurality of electrodes and said organic electroluminescent layer and emits light by light excitation based on irradiated excitation light, and said sealing layer that seals said light-emitting covering layer and has light-masking characteristics with respect to at least the light emitted by said light-emitting covering layer; and a defect inspection step for determining that a defect exists in said sealing layer when a light-emitting spot exists in said sealing layer, and for determining that a defect does not exist in said sealing layer when a light-emitting spot does not exist in said sealing layer.

22. A display panel manufacturing method, comprising the steps of:
a first electrode formation step for stacking a transparent first electrode on a substrate;
a light-emitting layer formation step for forming on said first electrode an organic electroluminescent layer that emits light by an electric field;
a second electrode formation step for forming a second electrode on said organic electroluminescent layer; a sealing layer formation step for forming a light-masking sealing layer that covers said first electrode, said organic electroluminescent layer, and said second electrode and has a transmissivity that is at least lower than that of said organic electroluminescent layer within a certain wavelength; and a light irradiation step for irradiating light on said light-masking sealing layer of each organic electroluminescent device of a display panel, said organic electroluminescent device comprising said substrate, said first electrode, said organic electroluminescent layer, said second electrode, and said light-masking sealing layer.
